(19) United States
(12) Patent Application Publication
(10) Pub. No.: US 2007/0029710 A1
(43) Pub. Date: Feb. 8, 2007

(54) Accumulator and spacer for accumulator

(76) Inventors: Tadanobu Takeuchi, Shizuoka (JP); Kenji Sasaki, Shizuoka (JP)

Correspondence Address: HARNESS, DICKEY & PIERCE, P.L.C., P.O. BOX 828, BLOOMFIELD HILLS, MI, 48303, US

(21) Appl. No.: 10/572,530

(22) PCT Filed: Sep. 24, 2004
(86) PCT No.: PCT/JP04/13889

§ 371 Date: Mar. 17, 2006

(30) Foreign Application Priority Data
Sep. 25, 2003 (JP) 2003-333049

(51) Int. Cl. F16F 9/04

(52) U.S. Cl. 267/64.27; 303/116.1; 267/64.11

(57) ABSTRACT

To prevent abnormal noise generation and bellows breakage by rattling, a metallic bellows type accumulator (1) comprising a housing (2) provided with a shell (3) and a gas end cover (4), a metallic bellows (7) arranged inside the housing (2), and a volume controlling spacer (22) fixed inside the gas end cover (4) is structured such that the spacer (22) is formed in a disc shape by a predetermined resin material, has a hole part (25) in a center of a flat surface, has a slit part (26) at one position on a circumference, has a larger outer diameter than an inner diameter at a position where the spacer is inserted in the gas end cover (4), is inserted to the gas end cover (4) in a state that the outer diameter is contracted, and is fixed inside the gas end cover (4) by its elastic restoring force.

This is a nationalization of PCT application of International Publication No. WO 2005/031171 published on Apr. 7, 2005.

### TECHNICAL FIELD

The present invention relates to an accumulator used as a pressure accumulating apparatus, a pulse pressure damping apparatus or the like, and a spacer for an accumulator serving as one of constituting elements thereof. The accumulator in accordance with the present invention is used, for example, as an accumulator for a motor vehicle.

### BACKGROUND ART

As shown in FIG. 5, a spacer 53 has been conventionally incorporated in an inner portion of a housing 51 in an accumulator for controlling a volume of a gas chamber 52, and a gap (not shown) is set between the spacer 53 and a bellows 54 for preventing interference of the spacer 53 with the expanding and contracting bellows 54. Further, an outer diameter of the spacer 53 is set to a dimension having a fitting tolerance with respect to an inner diameter of a gas end cover 55, whereby the spacer is incorporated so as to prevent generation of rattling with respect to the gas end cover 55 at a time of being originally assembled.

However, in accordance with the conventional structure, when a creep on the basis of an aged deterioration and a heat contraction on the basis of a heat cycle are generated in the spacer 53 formed in a disc shape by a predetermined resin material, the rattling with respect to the gas end cover 55 is generated in the spacer 53, whereby there is a case that an abnormal noise is generated or the bellows 54 is broken due to the above reason.

Patent Document 1

Japanese Unexamined Patent Publication No. 2002-276604 (FIG. 8)

### DISCLOSURE OF THE INVENTION

### Problem to be Solved by the Invention

The present invention is made by taking the points mentioned above into consideration, and an object of the present invention is to provide an accumulator, in which an occurrence of rattling of a volume controlling spacer incorporated in an inner portion of a housing of the accumulator due to an aged deterioration and a heat contraction can be suppressed, thereby generation of an abnormal noise and a breakage of bellows by the rattling being prevented, and a spacer for such the accumulator.

### MEANS FOR SOLVING THE PROBLEM

In order to achieve the object mentioned above, in accordance with a first aspect of the present invention, there is provided an accumulator comprising:

a spacer for controlling a volume provided in an inner portion of a housing,

wherein the spacer is formed in a disc shape by a predetermined resin material, has a hole part in a center of a flat surface, has a slit part at one position on a circumference, has a larger outer diameter than an inner diameter at a position where the spacer is inserted in the housing, is inserted to the housing in a state in which the outer diameter is contracted, and is fixed to an inner diameter side of the housing on the basis of its elastic restoring force.

Further, in accordance with a second aspect of the present invention, there is provided a metallic bellows type accumulator comprising:

a housing provided with a shell and a gas end cover;

a metallic bellows arranged in an inner portion of the housing; and

a volume controlling spacer fixed to an inner side of the gas end cover,

wherein the spacer is formed in a disc shape by a predetermined resin material, has a hole part in a center of a flat surface, has a slit part at one position on a circumference, has a larger outer diameter than an inner diameter at a position where the spacer is inserted in the gas end cover, is inserted to the gas end cover in a state in which the outer diameter is contracted, and is fixed to an inner diameter side of the gas end cover on the basis of its elastic restoring force.

Further, in accordance with a third aspect of the present invention, there is provided a volume controlling spacer for an accumulator, the spacer being incorporated in an inner portion of a housing of the accumulator,

wherein the spacer is formed in a disc shape by a predetermined resin material, has a hole part in a center of a flat surface, has a slit part at one position on a circumference, has a larger outer diameter than an inner diameter at a position where the spacer is inserted in the housing, is inserted to the housing in a state in which the outer diameter is contracted, and is fixed to an inner diameter side of the housing on the basis of its elastic restoring force.

Further, in accordance with a fourth aspect of the present invention, there is provided a volume controlling spacer for an accumulator, the spacer forming a constituting element of a metallic bellows type accumulator together with a housing provided with a shell and a gas end cover, and a metallic bellows arranged in an inner portion of the housing, and being fixed to an inner side of the gas end cover,

wherein the spacer is formed in a disc shape by a predetermined resin material, has a hole part in a center of a flat surface, has a slit part at one position on a circumference, has a larger outer diameter than an inner diameter at a position where the spacer is inserted in the gas end cover, is inserted to the gas end cover in a state in which the outer diameter is contracted, and is fixed to an inner diameter side of the gas end cover on the basis of its elastic restoring force.

In the accumulator in accordance with the first aspect of the present invention or the spacer in accordance with the third aspect provided with the structures mentioned above, since the disc-shaped spacer provided with the hole part and the slit part is inserted to the housing in a state in which the outer diameter thereof is contracted, and is fixed to the inner diameter side of the housing on the basis of its elastic restoring force, an elastic fitting margin is set by itself with respect to the housing, that is, the spacer is snap fitted to the inner diameter side of the housing, in spite that the spacer is made of the comparatively rigid resin. Accordingly, even if the aged deterioration, the heat contraction or the like is generated in the spacer within the fitting margin or an effective range of the snap fitting, a state in which the spacer is fixed to the inner diameter side of the housing can be maintained, whereby it is possible to suppress the occurrence of the rattling with respect to the housing in the spacer.

Further, in the accumulator in accordance with the second aspect of the present invention or the spacer in accordance with the fourth aspect provided with the structures mentioned above, since the disc-shaped spacer provided with the hole part and the slit part is inserted to the gas end cover of the housing in a state in which the outer diameter thereof is contracted, and is fixed to the inner diameter side of the gas end cover on the basis of its elastic restoring force, an elastic fitting margin is set by itself with respect to the gas end cover, that is, the spacer is snap fitted to the inner diameter side of the gas end cover, in spite that the spacer is made of the comparatively rigid resin. Accordingly, even if the aged deterioration, the heat contraction or the like is generated in the spacer within the fitting margin or an effective range of the snap fitting, a state in which the spacer is fixed to the inner diameter side of the gas end cover can be maintained, whereby it is possible to suppress the occurrence of the rattling with respect to the gas end cover in the spacer.

### EFFECT OF THE INVENTION

The present invention achieved the following effects.

In the accumulator in accordance with the first aspect of the present invention, or the spacer in accordance with the third aspect, since the disc-shaped spacer provided with the hole part and the slit part is inserted to the housing in a state in which the outer diameter thereof is contracted, and is fixed to the inner diameter side of the housing on the basis of its elastic restoring force as mentioned above, an elastic fitting margin is set by the spacer itself with respect to the housing, and the spacer is snap fitted to the inner diameter side of the housing, in spite that the spacer is made of the comparatively rigid resin. Accordingly, even if the aged deterioration, the heat contraction or the like is generated in the spacer within the fitting margin or an effective range of the snap fitting, a state in which the spacer is fixed to the inner diameter side of the housing can be maintained, whereby it is possible to suppress the occurrence of the rattling with respect to the housing in the spacer. Therefore, since it is possible to prevent generation of the abnormal noise in the accumulator and the breakage of bellows due to the rattling, it is possible to provide the accumulator which is excellent in a quietness and a durability. Further, since an installing work of the spacer is constituted by a procedure of inserting the spacer to the inner diameter side of the housing in a state in which the spacer is elastically contracted, there can be obtained features that the spacer is easily centered and the installing work is easily executed.

Further, in the accumulator in accordance with the second aspect of the present invention, or the spacer in accordance with the fourth aspect, since the disc-shaped spacer provided with the hole part and the slit part is inserted to the gas end cover of the housing in a state in which the outer diameter thereof is contracted, and is fixed to the inner diameter side of the gas end cover on the basis of its elastic restoring force as mentioned above, an elastic fitting margin is set by the spacer itself with respect to the gas end cover, and the spacer is snap fitted to the inner diameter side of the gas end cover, in spite that the spacer is made of the comparatively rigid resin. Accordingly, even if the aged deterioration, the heat contraction or the like is generated in the spacer within the fitting margin or an effective range of the snap fitting, a state in which the spacer is fixed to the inner diameter side of the gas end cover can be maintained, whereby it is possible to suppress the occurrence of the rattling with respect to the gas end cover in the spacer. Therefore, since it is possible to prevent generation of the abnormal noise in the accumulator and breakage of the bellows due to the rattling, it is possible to provide the metallic bellows type accumulator which is excellent in a quietness and a durability. Further, since an installing work of the spacer is constituted by a procedure of inserting the spacer to the inner diameter side of the gas end cover in a state in which the spacer is elastically contracted, there can be obtained features that the spacer is easily centered and the installing work is easily executed.

### BRIEF DESCRIPTION OF THE DRAWINGS

FIG. 1 is a cross sectional view of an accumulator in accordance with an embodiment of the present invention;

FIGS. 2A and 2B are views showing a spacer singly, in which FIG. 2A is a plan view and FIG. 2B is a front view;

FIGS. 3A to 3C are views showing the spacer singly, in which FIG. 3A is a side view, FIG. 3B is a back view and FIG. 3C is a bottom view;

FIGS. 4A and 4B are views showing the spacer singly unit, in which FIG. 4A is a cross sectional view along a line A-A in FIG. 2A, and FIG. 4B is a cross sectional view along a line B-B in FIG. 2B; and

FIG. 5 is a cross sectional view of an accumulator in accordance with a prior art.

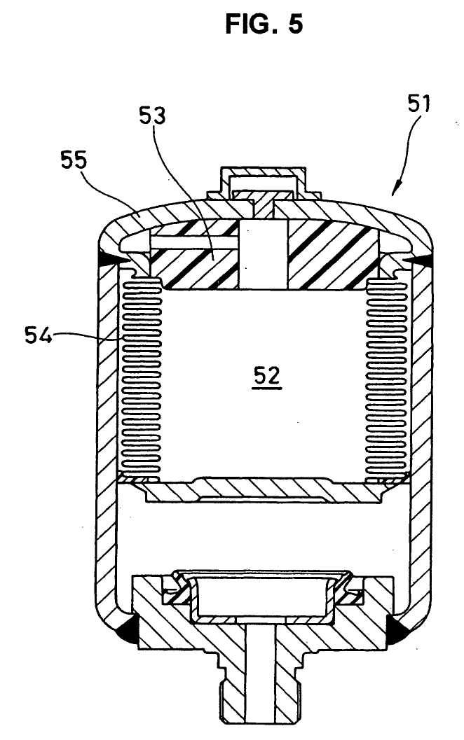

### DESCRIPTION OF REFERENCE NUMERALS

1 accumulator
2 housing
3 shell
4 gas end cover
4a flange portion
5 oil port
6 actuating member
7 bellows
8 bellows cap
9 gas chamber
10 pressure chamber
11 damping ring
12 gas inlet port
13 gas plug
14 hexagon nut
15 mounting portion
16 thread portion
17 pressure inflow port
18 installing portion
19 seal holder
20 packing
21 chamber space
22 spacer
23 large-diameter disc portion
24 small-diameter disc portion
25 hole part
26 slit part
26a upper slit part
26b lower slit part
27 spacer outer peripheral space
28 groove portion

### BEST MODE FOR CARRYING OUT THE INVENTION

In the present invention, a spacer is formed by a predetermined resin material. A kind of the resin material is not particularly limited, however, if a thermosetting resin (for example, a phenol resin) is employed, it is possible to avoid a heat influence generated at a time of laser welding of a gas end cover. On the contrary, if a conventionally used polyamide resin (PA66) or the like is employed, there is a possibility that the spacer melts down from the gas end cover due to the heat at a time of laser welding of the gas end cover. The laser welding is executed at a time of fixing a bellows, a shell or the like to the gas end cover.

### Embodiment

Next, a description will be given of an embodiment in accordance with the present invention with reference to the accompanying drawings.

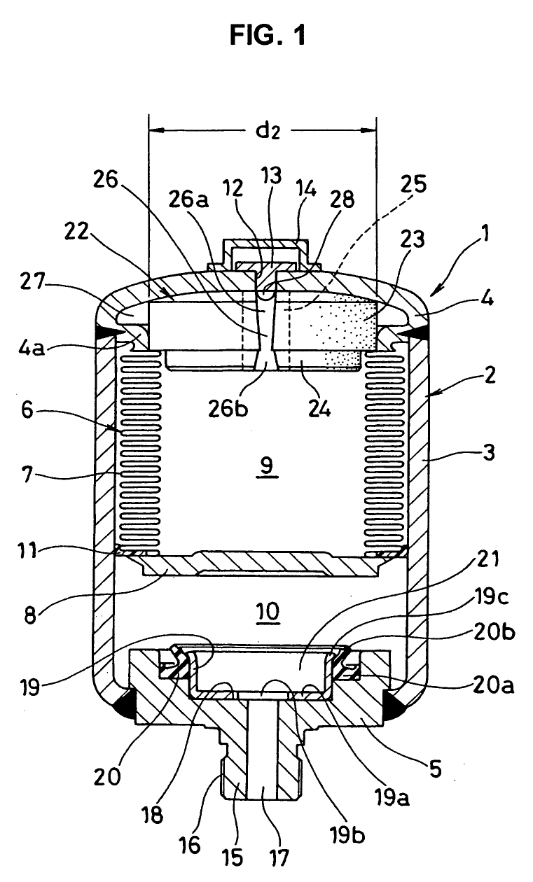

FIG. 1 shows a cross section of an accumulator 1 in accordance with an embodiment of the present invention. The accumulator 1 in accordance with the embodiment is constituted by a metallic bellows type accumulator, and is structured as follows.

First, a gas end cover 4 and an oil port (an oil port member) 5 are fixed (welded) to both end portions of a shell 3 formed in an approximately cylindrical shape, a housing 2 is provided thereby, and an actuating member 6 provided with a bellows 7 and a bellows cap 8 is accommodated in an inner portion of the housing 2. The gas end cover 4 may be integrally formed with the shell 3, and the oil port 5 may be integrally formed with the shell 3.

The bellows 7 is structured such that one end portion (a fixed end portion) thereof is fixed (welded) to the gas end cover 4 and the other end portion (a floating end portion) is fixed (welded) to the bellows cap 8, whereby an inner portion of the housing 2 is sectioned into a gas chamber 9 in an inner side of the actuating member 6 and a pressure chamber (a liquid chamber) 10 in an outer side thereof by the actuating member 6 constituted by the bellows 7 and the bellows cap 8. A damping ring 11 brought into slidable contact with an inner surface of the shell 3 is attached to an outer periphery of the other end portion of the bellows 7 so as to prevent the bellows 7 from scraping against the shell 3. A metallic bellows constituted by an electroformed bellows, a mold bellows, a weld bellows or the like is used as the bellows 7, however, a bellows made of the other material can be used in accordance with a specification, an intended use or the like of the accumulator 1. The bellows cap 8 may be integrally formed with the bellows 7. Further, one end portion of the bellows 7 is fixed to a lower surface of an inward flange portion 4a provided in an outer peripheral edge portion of the gas end cover 4, however, in the case that an annular mounting member (not shown) is fixed thereto in place of the flange portion 4a, one end portion of the bellows 7 is fixed to the mounting member.

A gas inlet port 12 for injecting a gas to the gas chamber 9 is provided in the gas end cover 4 constituting a part of the housing 2 mentioned above, and a gas plug 13 for closing the inlet port 12 is attached to the inlet port 12 and is covered by a hexagon nut 14. Accordingly, before fixing the gas plug 13 and the hexagon nut 14, a gas having a predetermined pressure is injected to the gas chamber 9 from the inlet port 12, and the gas having the predetermined pressure is sealed in the gas chamber by fixing (welding) the gas plug 13 and the hexagon nut 14 after the injection. As a kind of the sealed gas, a nitrogen gas or the like is preferable.

Further, the oil port 5 constituting also a part of the housing 2 is provided with a tubular mounting portion 15 having a thread portion 16 for connecting the accumulator 1 to a pressure piping in a hydraulic system side (not shown) or the like, and the mounting portion 15 is provided with a pressure inflow port (an oil port in a narrow sense) 17 for introducing a pressure fluid in the piping side to the pressure chamber 10. Accordingly, the accumulator 1 is connected to the piping side with the mounting portion 15, and the pressure in the piping side is introduced to the pressure chamber 10 from the pressure inflow port 17.

An annular installing portion 18 provided with an annular step and formed in a concave shape is provided in an inner surface of the oil port 5 and a peripheral edge portion of an opening of the pressure inflow port 17, a seal holder 19 is attached to an inner peripheral side step portion of the installing portion 18, and a packing (a seal) 20 corresponding to a seal member is installed in an outer peripheral side of the seal holder 19 and in an outer peripheral side step portion of the installing portion 18.

The seal holder 19 is formed in an annular shape by a metal material such as a sheet metal or the like, and a half cut section thereof is formed in an approximately L shape by integrally forming a tubular portion 19c on an outer peripheral edge portion of a disc-shaped flat surface portion 19a having a through hole 19b provided in a center of the flat surface. The seal holder 19 is fixed to the installing portion 18 in accordance with a pressure insertion, a welding, an adhesion or the other means, and a chamber space 21 for preventing an abnormal noise is formed in an inner side of the seal holder 19, that is, an inner peripheral side of tubular portion 19c under so fixed state.

The packing 20 is formed in an annular shape by a predetermined rubber-like elastic body, and is formed as a lip seal in which an outward seal lip 20b is integrally formed in one end of a base portion 20a thereof. The packing 20 is installed in the mounting portion 18 mentioned above by means of a pressure inserting or the like without being adhered, and prevented from coming off by such structure that a leading end of the tubular portion 19c of the seal holder 19 (a leading end portion of the seal holder 19) is bent obliquely toward an outer side in a diametrical direction (in a trumpet shape).

The packing 20 is provided for suppressing a further reduction of the pressure in the pressure chamber 10, thereby preventing the bellows 7 from expanding in a diametrical direction so as to scrape against the shell 3, on the basis of a seal effect generated by the bellows cap 8 brought into contact with the packing 20 at a time when a pressure in the pressure chamber 10 is lowered and the bellows 7 is elongated.

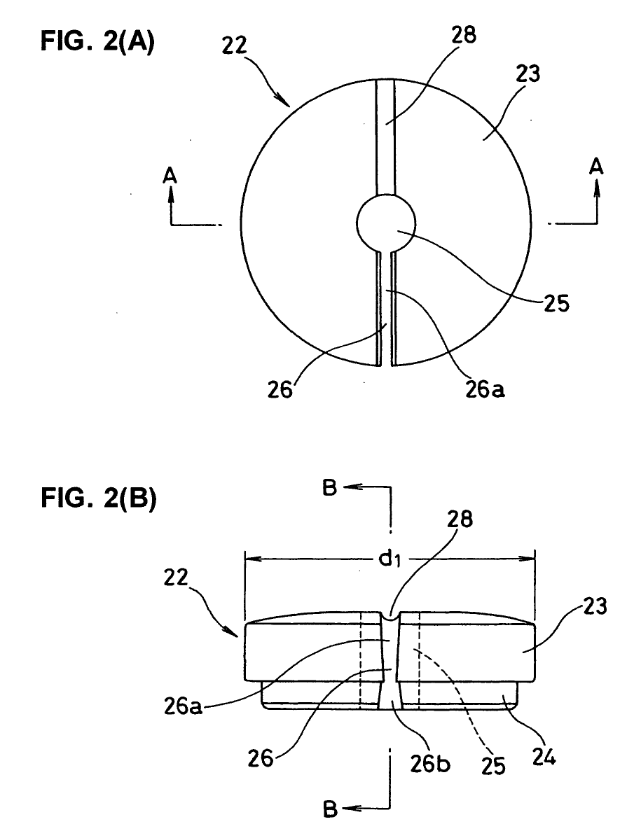

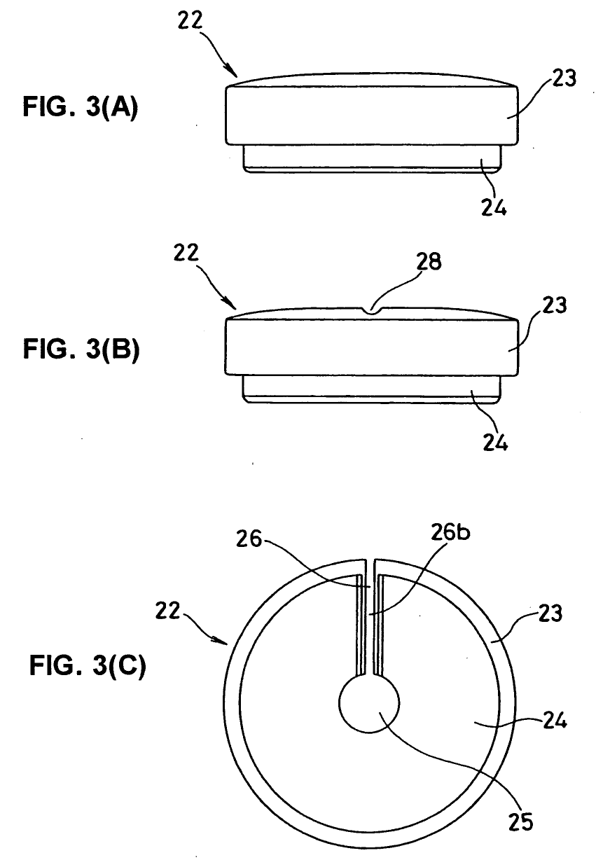

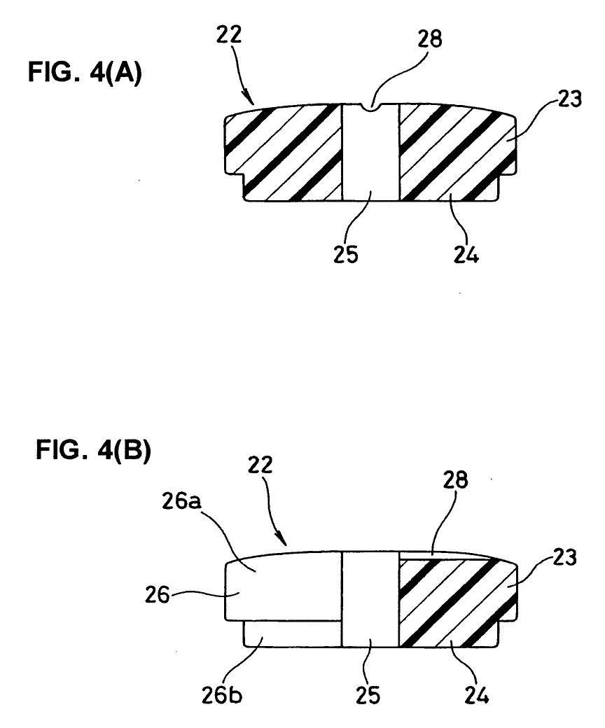

Further, a spacer 22 for controlling a volume of the gas chamber 9 is installed in an inner side of the gas end cover 4, in the gas chamber 9 in the inner portion of the housing 2 mentioned above, and the spacer 22 is structured as follows in the embodiment. In this case, for the sake of convenience for drawing, the spacer 22 is drawn by an outer appearance in FIG. 1. FIGS. 2 to 4 show a single part of the spacer 22.

The spacer 22 is formed in a disc shape by a phenol resin corresponding to one kind of a thermosetting resin, a hole part 25 is formed in a center of a flat surface thereof and a slit part 26 is formed at one position on a circumference, whereby the spacer 22 can be elastically deformed in a diametrical direction so as to change a diameter thereof. Further, an outer diameter d1 (refer to FIG. 2B) of the spacer 22 in a free state (before being installed) is formed slightly larger than an inner diameter d2 (refer to FIG. 1) of the flange portion 4a corresponding to the position to which the spacer is inserted in the gas end cover 4, whereby the spacer 22 is structured such as to be elastically fitted to the inner diameter side of the gas end cover 4 on the basis of an elastic restoring force of the spacer by being inserted to the gas end cover 4 in a state in which the outer diameter d1 is contracted. This fitting corresponds to a so-called snap fitting.

Further, a small-diameter disc portion (a volume controlling portion) 24 arranged in an inner diameter side of the bellows 7 and having a comparatively small diameter is integrally formed coaxially in a lower surface side of a large-diameter disc portion (a fixed portion) 23 fixed to the inner diameter side of the gas end cover 4 and having a comparatively large diameter, in the spacer 22 formed in a disc shape as a whole, the small-diameter disc portion 24 is formed so as to have a smaller diameter than the inner diameter of the bellows 7 as illustrated, and a diametrical gap is formed between both the elements. Accordingly, since the small-diameter disc portion 24 can be extended toward a lower side without being interfered with the bellows 7, it is possible to control the volume of the spacer 22 or the volume of the gas chamber 9 even if the volume of the large-diameter disc portion 23 is fixed.

The hole part 25 is provided as a hole having a circular shape in a flat surface as shown in FIG. 2A, and is formed so as to pass through the spacer 22 in a vertical direction (a thickness direction). The hole part 25 makes the spacer 22 be elastically deformable as mentioned above, and makes the gas inlet port 12 communicate with the gas chamber 9 in an installed state, thereby serving as a gas inlet path at a time of injecting the gas.

The slit part 26 is formed so as to cut the spacer 22 made in the annular shape by forming the hole part 25 at one position on the circumference thereof, is formed such that a width is enlarged gradually toward an upper side in a portion (an upper slit part) 26a formed in the large-diameter disc portion 23, and is formed such that the width is enlarged gradually toward a lower side contrarily in a portion (a lower slit part) 26b formed in the small-diameter disc portion 24, as shown in FIG. 1 or 2B. The slit part 26 makes the spacer 22 be elastically deformable as mentioned above, and serves as a communication path for making a spacer outer peripheral space 27 sealed by the spacer 22 in an installed state, communicate with the gas chamber 9 and the hole part 25 so as to balance the pressure.

Further, as shown in FIGS. 2A and 2B, a groove portion 28 is provided along a radial direction at a symmetrical position at 180 degree of the slit part 26 and on an upper surface of the spacer 22, and the groove portion 28 serves also as the communication path for making the spacer outer peripheral space 27 communicate with the gas chamber 9 and the hole part 25 so as to balance the pressure.

The accumulator 1 having the structure mentioned above is structured, for example, such as to be connected to the pressure piping of the hydraulic system as mentioned above, and operate so as to absorb a pulsation of the pressure generated in the pressure piping, and is characterized by a point that the following operations and effects can be achieved by the structure mentioned above.

In the gas chamber volume controlling spacer 22 installed in the inner side of the gas end cover 4 in the housing 2 as mentioned above, the spacer 22 is formed in the disc shape by the phenol resin corresponding to the thermosetting resin, the hole part 25 is provided in the center of the flat surface, the slit part 26 is provided at one position on the circumference, the outer diameter d1 thereof is set larger than the inner diameter d2 of the flange portion 4a corresponding to the position to which the spacer is inserted in the gas end cover 4, and the spacer 22 is structured such as to be inserted to the gas end cover 4 in the state in which the outer diameter d1 is contracted so as to be fixed to the inner diameter side of the gas end cover 4 by the elastic restoring force. In accordance with the structure, the elastic fitting margin with respect to the gas end cover 4 is set in the spacer 22, and the spacer 22 is snap fitted to the inner diameter side of the gas end cover 4. Accordingly, even if an aged deterioration, a heat contraction or the like is generated in the spacer 22 within the fitting margin or within an effective range of the snap fitting, the state in which the spacer 22 is fixed to the inner diameter side of the gas end cover 4 is maintained. Accordingly, it is possible to suppress the occurrence of the rattling with respect to the gas end cover 4 in the spacer 22. Therefore, it is possible to prevent generation of an abnormal noise in the accumulator 1 and breakage of the bellows 7 due to the rattling. Further, since the installing work of the spacer 22 is constituted by a procedure of inserting the spacer 22 to the inner diameter side of the gas end cover 4 in a state in which the spacer 22 is elastically contracted, it is possible to easily execute a centering work of the spacer 22, and it is possible to easily execute the installing work.

Further, since the spacer 22 is formed by the thermosetting resin such as the phenol resin or the like as mentioned above, it is possible to prevent melting down of the spacer 22 from the gas end cover 4 on the basis of the influence of the heat at a time of laser welding the gas end cover 4. The thermosetting resin becomes only hard even if it is thermally deteriorated. The laser welding is executed at a time of fixing the metallic bellows 7 to the lower surface of the flange portion 4a of the gas end cover 4.

What is claimed is:

1. An accumulator comprising:
a spacer for controlling a volume provided in an inner portion of a housing,
wherein said spacer is formed in a disc shape by a predetermined resin material, has a hole part in a center of a flat surface, has a slit part at one position on a circumference, has a larger outer diameter than an inner diameter at a position where the spacer is inserted in said housing, is inserted to said housing in a state in which said outer diameter is contracted, and is fixed to an inner diameter side of said housing on the basis of its elastic restoring force.

2. A metallic bellows type accumulator comprising:
the housing provided with a shell and a gas end cover;
a metallic bellows arranged in an inner portion of said housing; and
a volume controlling spacer fixed to an inner side of said gas end cover,
wherein said spacer is formed in a disc shape by a predetermined resin material, has the hole part in a center of a flat surface, has the slit part at one position on a circumference, has the larger outer diameter than the inner diameter at a position where the spacer is inserted in said gas end cover, is inserted to said gas end cover in a state in which said outer diameter is contracted, and is fixed to the inner diameter side of said gas end cover on the basis of its elastic restoring force.

3. The volume controlling spacer for the accumulator, the spacer being incorporated in an inner portion of the housing of the accumulator,
wherein said spacer is formed in the disc shape by the predetermined resin material, has the hole part in a center of a flat surface, has the slit part at one position on a circumference, has the larger outer diameter than the inner diameter at a position where the spacer is inserted in said housing, is inserted to said housing in a state in which said outer diameter is contracted, and is fixed to an inner diameter side of said housing on the basis of its elastic restoring force.

4. The volume controlling spacer for the accumulator, the spacer forming a constituting element of the metallic bellows type accumulator together with the housing provided with the shell and the gas end cover, and the metallic bellows arranged in the inner portion of said housing, and being fixed to an inner side of said gas end cover,
wherein said spacer is formed in a disc shape by a predetermined resin material, has the hole part in a center of a flat surface, has the slit part at one position on a circumference, has the larger outer diameter than the inner diameter at a position where the spacer is inserted in said gas end cover, is inserted to said gas end cover in a state in which said outer diameter is contracted, and is fixed to the inner diameter side of said gas end cover on the basis of its elastic restoring force.
